(19) United States
(12) Patent Application Publication
(10) Pub. No.: US 2017/0210208 A1
(43) Pub. Date: Jul. 27, 2017

(54) VEHICLE SHADE ASSEMBLY AND A VEHICLE REAR WINDOW PACKAGE TRAY SHADE ASSEMBLY

(71) Applicant: Ford Global Technologies, LLC, Dearborn, MI (US)

(72) Inventors: Kadin Zhang, Nanjing (CN); Peter Zhang, Nanjing (CN); Yoyo Ma, Nanjing (CN); Raymond Fu, Nanjing (CN)

(21) Appl. No.: 15/411,008

(22) Filed: Jan. 20, 2017

(30) Foreign Application Priority Data
Jan. 22, 2016 (CN) 201610045545.3

(51) Int. Cl. B60J 3/02; E06B 9/56; E06B 9/70; E06B 9/44

(52) U.S. Cl. CPC B60J 3/02; E06B 9/44; E06B 9/56; E06B 9/70

(57) ABSTRACT

The invention provides shade assembly in a vehicle comprising a housing including a gap for moving in and out of a shade; and a cover having a first segment and a second segment. The cover is connected to the housing and moveable with the shade between a closed position to conceal the gap and an open position exposing the gap and the first segment contacts an outer side of the housing and the second segment contacts an inner side at the closed position.

### RELATED APPLICATION

This application claims the benefit of Chinese Patent Application No.: CN 201610045545.3 filed on Jan. 22, 2016, the entire contents thereof being incorporated herein by reference.

### FIELD OF THE INVENTION

The present application relates a vehicle shade assembly and a vehicle shade assembly at a vehicle's rear window package tray with a cover to conceal a gap of housing at a closed position.

### BACKGROUND OF THE INVENTION

A vehicle may include a shade assembly for shielding a window from light or sunshine. For example, a shade assembly may be disposed on a package tray of a rear window to shield the rear window.

U.S. Pat. No. 7,089,992B2 discloses a shade assembly used in a vehicle, which comprises a pivotable cover disposed on a slot. The cover may be extended to an open position via a spring to provide a passage for a shade to be extended and may be driven to a closed position to cover the shade when the shade is retracted. However, there are uneven gaps existed between the cover and sidewalls of the housing. At a closed position, the cover cannot completely cover the slot and some small objects may falls falling into the interior of the shade assemble through the slot, which may cause wearing or even damage on the shade assembly. In addition, the gap is visible to the users and causes unsatisfactory appearance.

### SUMMARY

According to an aspect of the present disclosure, a vehicle shade assembly and a vehicle's rear window package tray is provided, which can cover the gap between in the housings. The shade assembly comprises a housing and a cover having a first segment and a second segment. The housing includes a gap for moving in and out of a shade. The cover is connected to the housing and moveable with the shade between a closed position to conceal the gap and an open position to expose the gap, and the first segment of the cover contacts an outer side of the housing and the second segment contacts an inner side of the housing.

In one embodiment, the second segment is configured to extend from the first segment, and the first and the second segments are in different planes.

In another embodiment, a length of the first segment is greater than a length of the second segment at a direction of a shade movement.

In another embodiment, the first segment is configured to bend toward to the inner side of the housing to contact the outer side of the housing at the closing position.

In another embodiment, the second segment is configured to bend toward to the outer side of the housing to contact the inner side of the housing at closing position.

In another embodiment, the cover includes a pivot shaft disposed at the inner side of the housing and connected with the housing.

In another embodiment, the cover includes a bias member to bias the cover to a position to expose the gap

In another embodiment, the bias member is a bias spring sleeved on the pivot shaft of the cover.

In another embodiment, a cover includes an actuator having an angle with the second segment of cover.

In another embodiment, the first segment, the second segment, and the actuator integrally formed.

In another embodiment, the shade wound on a reel is activated by a top rod to move in and out of the housing. When the shade is moved to the interior of the housing from the exterior, the top rod pushes the actuator cover to rotate the first and second segment to the closed position to conceal the gap, When the shade is moved to the exterior of the housing from the interior, the top rod pushes the first segment of the cover to rotate the cover to expose the gap.

In another embodiment, the top rod is driven by a motor.

In another embodiment, the housing is vehicle a package tray of a rear window.

According to another aspect, a shade assembly is provided for a rear window package tray in a vehicle. The shade assembly comprises a package tray of the rear window and a cover pivotably connected with the package tray. The package tray includes a gap to allow movement of a shade in and out of the gap, and the shade is driven by a top rod. The cover is moveable between a closed position to conceal the gap and an open position to expose the gap, and the cover includes a first segment and a second segment extending from the first segment and forming an angle with the first segment. The first segment of the cover contacts an outer side of the package tray and the second segment contacts an inner side of the package tray.

In one embodiment, the second segment is configured to bend toward to the outer side of the rear window package tray to contact the inner side of the housing at closing position.

In one embodiment, the cover includes an actuator disposed on opposite ends of the cover. The actuators extend from the first segment and bends from end portions of the first segment toward the first segment.

In another embodiment, the first segment and the second segment, and actuator are molded together as one piece.

According to another aspect, the cover is provided to be used in a shade assembly in a vehicle to conceal a gap. The cover comprises a first segment having a width adapted to a length of the gap in a housing; a second segment extending from the first segment at a length direction and located in a plane different from the first segment; and at least one actuator disposed on one end of the cover. The first segment contacts an outer side of the housing and the second segment contacts an inner side of the housing at a closed position to conceal the gap.

In one embodiment, the first segment is a curved plate bended toward a first direction and the second segment is a curved plate bended to a second direction opposite to the first direction, and wherein the actuator extends from the first segment and curved toward the first segment and away from the second segment.

In another embodiment, a length of first segment is greater than a length of the second segment.

In another embodiment, the cover includes two actuators at two opposite ends and wherein the first segment, the second segment and the actuators are integrally formed.

The shade assemblies of the present disclosure have several advantages. For example, a cover is provided to cover a gap that allows the movement of a shade in and out. A first segment of the cover contacts an outer side of the housing or the package tray and a second segment of the cover contacts an inner side of the housing or the package tray at the closed position when a shade is moved into the interior of the housing or the package tray. In this way, the gap in the housing is concealed, which provide better appearance and prevent small object to fall into the interior of the housing or the package tray.

### BRIEF DESCRIPTION OF DRAWINGS

FIG. 1 is a perspective view of a shade assembly according to an example embodiments of the present disclosure, illustrating a cover rotated between a closed position and an open position;

FIG. 2 a perspective view of the shade assembly in FIG. 1, illustrate a shade of the shade assembly at an open position;

FIG. 3 is schematic diagram, illustrating the shade assembly actuated to an open position from a closed position;

FIG. 4 is a partial enlarged view of the shade assembly in FIG. 3;

FIG. 5 is a schematic diagram of the shade assembly at a closed position;

FIG. 6 is a perspective view of a cover of shade assembly according to one embodiment of the present disclosure;

FIG. 7 is a perspective cross-sectional view of a shade assembly according to one embodiment of the present disclosure;

FIG. 8 is a diagram of a shade assembly at a closed position, illustrating principle of an operation;

FIG. 9 a schema diagram of the shade assembly at open position illustrating principle of an operation;

FIG. 10 is a schematic diagram of side view of the shade assembly in FIG. 6.

### DETAILED DESCRIPTION

Shade assemblies will be described in detail below with reference to the figures.

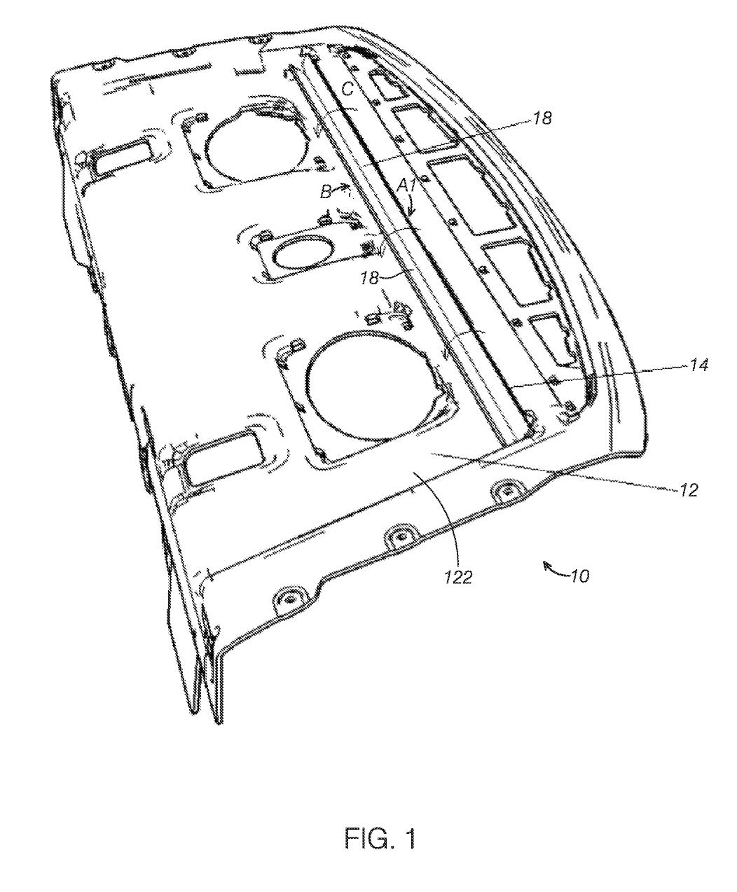

FIGS. 1 to 3 show a shade assembly 10 for a vehicle according to one embodiment of the present disclosure. The shade assembly 10 comprises a housing 12 having a gap 14 to allow a shade 16 move in and out the housing 12. The shade assembly 10 further includes a cover 18 pivotally connected with the housing 12 and is movable in and out with the shade 16 to conceal the gap 14 at a closed position and expose the gap 14 at an opening position. The cover 18 includes a cover portion 19 contacting on an inner side and an outer side of the housing 12 at closed position.

Referring to FIG. 1, the closed position of the cover 18 is shown at A1; and the open position of the cover is shown at B1. In the process of actuating the shade 16 to deploy (i.e., the shade 16 moving from a stowed position to a deployed position, the cover 18 pivots along a direction of the arrow C from the closed position A1 to the open position B1.

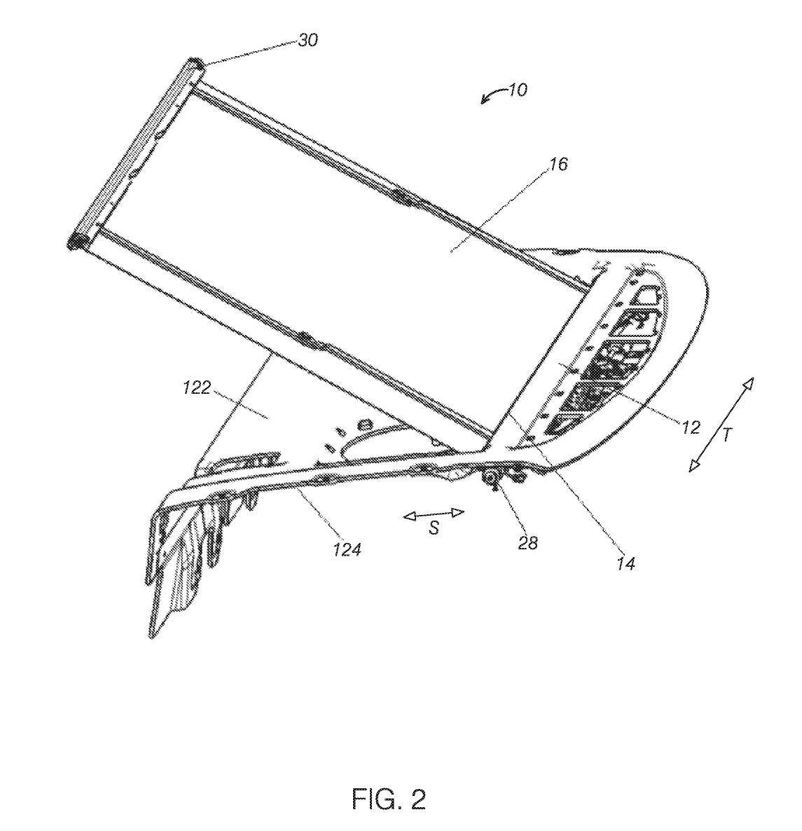

Continuing with FIG. 1 and with reference FIG. 2, the housing 12 has an outer side 122 and an inner side 124. The inner side 124 refers to the side of the housing facing an interior of the shade assembly 10 and opposite to the outer side 122. The outer side 122 refers the side facing an interior of the vehicle. For example, the inner side 124 is the side toward the interior of the shade assembly 10 and the outside is the side facing an interior space of the vehicle. In other words, as shown in FIG. 1, the inner side 124 is a side of the housing 12 that includes vehicle's parts or vehicle's frame; and the outer side 122 is a side of housing that faces the vehicle's inside space or the side visible by a user.

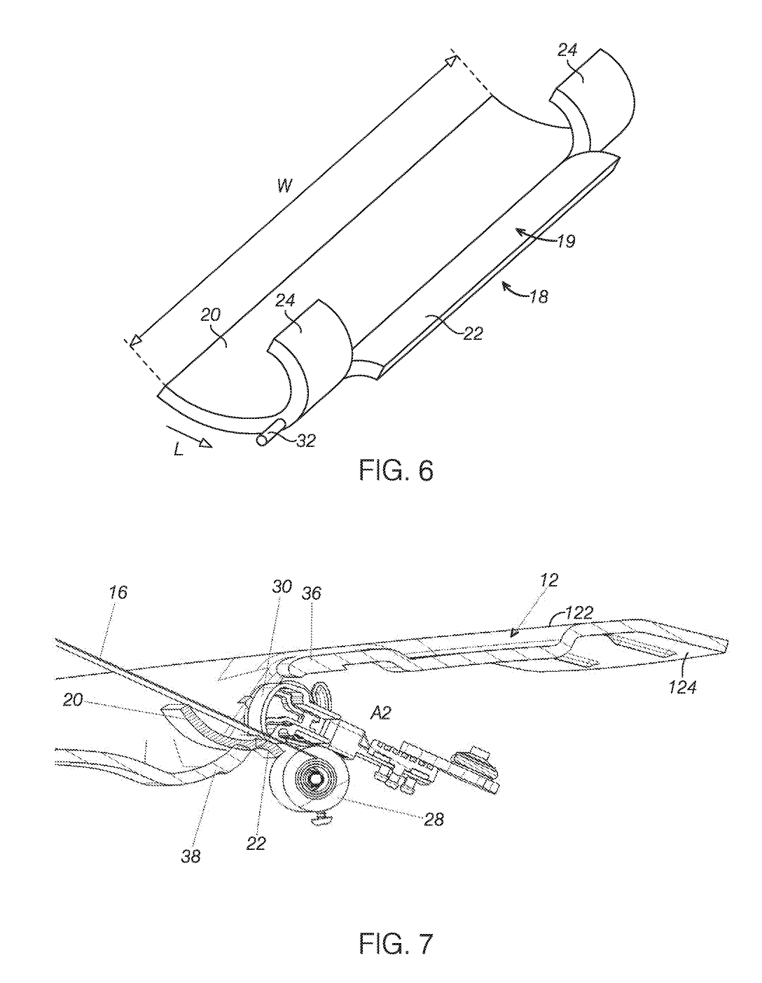

Referring to FIG. 6, in some embodiments, the cover 18 further includes a pivot shaft 32 connected with the housing 12. In some embodiment, the pivot shaft 32 may be positioned adjacent to an interior of the housing 12. Alternatively, the cover 18 may include a pivot portion without a shaft, such as a protrusion or a rib that can function as a pivot. In another embodiment, the pivot shaft may be disposed on the housing 12, and the pivot portion of the cover 18 may be configured as a slot to receive the pivot shaft on the housing 12.

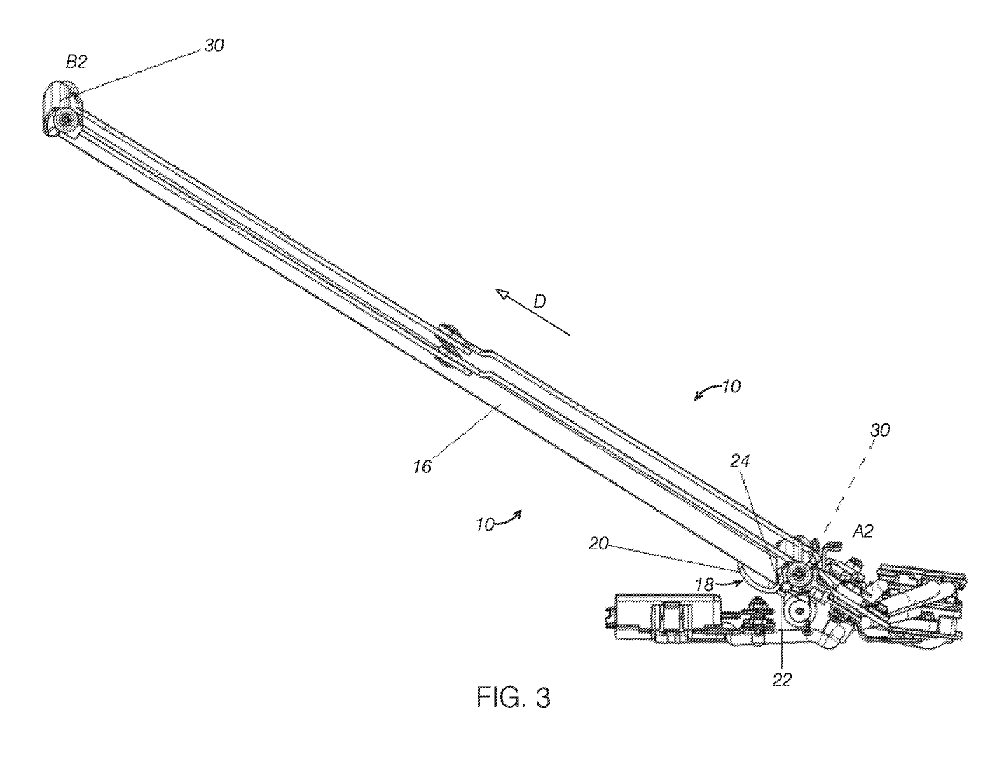

As shown in FIG. 3 to FIG. 6, the cover 18 may be used to cover the gap 14. The gap is disposed on the housing 12 and configured to have a length and a width and configured to allow the movement of the shade 16 in and out of the housing. The length of the gap 14 refers to a dimension at a direction T or a traverse direction of the vehicle. The width of the gap 14 refers to a dimension at a direction S or a longitudinal direction of the vehicle. In some embodiments, the cover portion 19 of the cover 18 includes a first segment 20 and a second segment 22. Referring to FIG. 6, the first segment 20 may have a width W adapted to the length of the gap 14. That is, the first segment 20 has the width smaller than the length of the gap 14 to allow its movement in the gap 14 while concealing the gap with a desired clearance at the closed position. The second segment 22 may extend from the first segment 20 at a length direction L and may be located in a plane different from the first segment 20. In some embodiment, the first segment 20 may be a curved plate bended toward first direction and the second segment 22 may be a curved plate bended to a second direction opposite to the first direction. When the cover 18 is disposed at the closed position, the first direction points toward the interior of the housing and the second direction points toward the exterior of the housing 12. At the closed position, the first segment 20 of the cover 18 contacts the outer side 122 of the housing 12 and the second segment 22 of the cover 18 contact the inner side 124 of the housing to conceal the gap 14. In some embodiments, the outer side 122 may refer to an outer side surface of the housing 12 and the inner side 124 may refer to an inner surface of the housing 12.

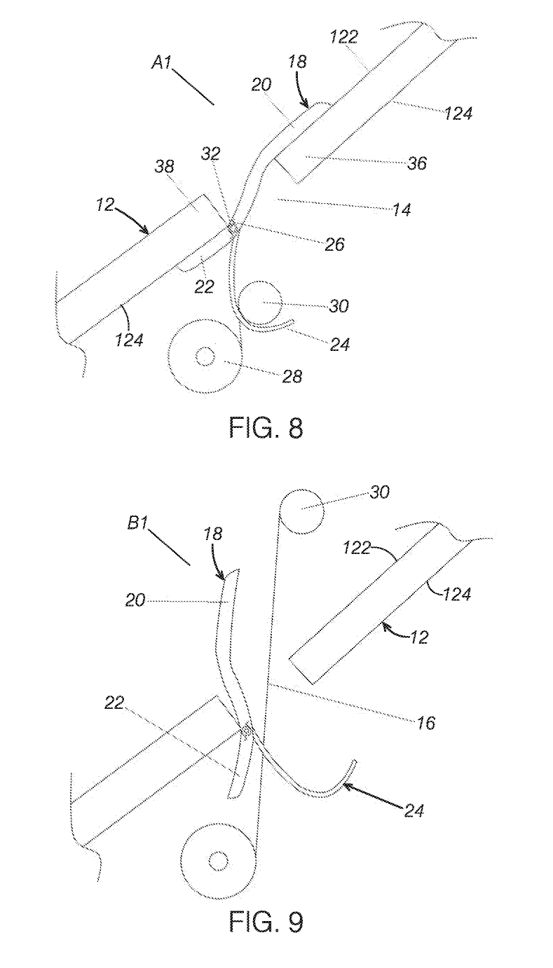

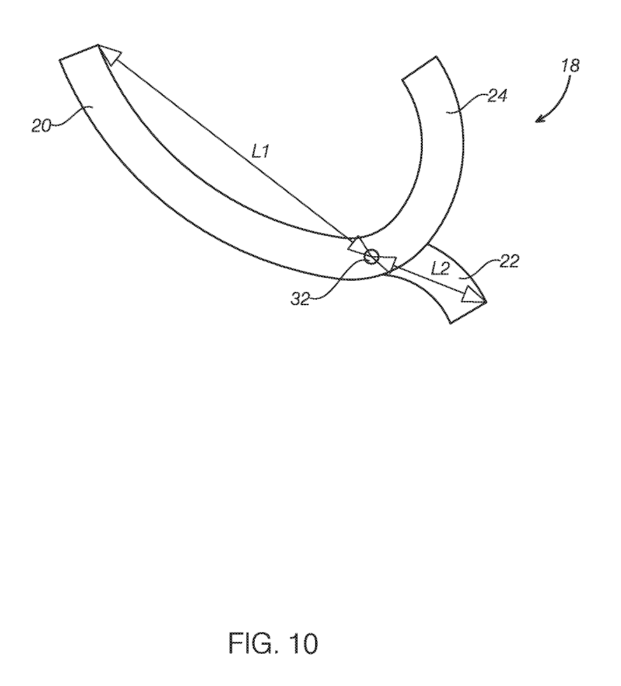

As show in FIGS. 8 and 9, in some embodiments, a length of the first segment 20 is greater than a length of the second segment 22. Further, the pivot shaft 32 of the cover 18 may be positioned at the inner side of the housing 12. A distance L1 between a free end of the first segment 20 and the pivot shaft 32 is greater than a distance L2 between a free end of the second segment 22 and the pivot shaft 32, as shown in FIG. 10. In other words, the pivot shaft 32 is closer to the free end of the second segment 22 than to the free end of the first segment 20. The free ends refer to the ends of the first segment 20 and the second segment 22 that contact the housing 12. Since the pivot shaft 32 is positioned at the inner side of the housing 12 which is an invisible lower part of the housing 12, the interfere to the movement of the shade 16 during a rotation due to a longer length of the second segment 22 can be avoided.

The configuration and movements of the parts will be described in detail with reference to FIGS. 8 and 9. As shown FIG. 8, in some embodiments, the first segment of the cover 18 contacts the outer side 122 of the housing 12 and the second segment 22 contacts the inner side 124 of the house at the closed position such that the gap 14 is concealed or covered. The housing 12 may include a first portion 36 and a second portion 38. The gap 14 is formed between the first portion 36 and the second portion 38, and extends along with left and right directions of the vehicle or a traverse direction of the vehicle. At the closed position, the first segment 20 contacts the outer side 122 or the outer surface of the first portion 36 and the second segment contacts the inner side 124 or the inner surface of the second end 38 to conceal the gap 14 that is between first portion 36 and the second portion 38 completely so that the gap is invisible to the user. Therefore, the shade assembly of the present disclosure can improve the appearance and prevent small items from falling into the housing.

As shown in FIGS. 7 and 8, in some embodiments, to better fit the first portion 36 and second portion 38 of the housing 12, the first segment 20 is configured to be bended toward the interior or the inner side of the housing 12 to facilitate the contact with the outer side 122 of the housing 12 at the closed position A1. In some embodiments, the second segment 22 is configured to be bended toward to the exterior or the outer side of the housing 12 to facilitate the contact with the inner side 124 of the housing 12 at the closed position A1. Such configuration enables the contact between the first segment 20 and the outer side 122 of the housing 12 and the contact between the second segment 22 and the inner side 124 of the housing 12 and thus the cover can conceal the gap firmly and provide a better appearance.

Preferably, the cover 18 is a curved plate with smooth transition to make the shade assembly have a better appearance.

In some embodiments, to ensure the cover 18 not shaking due to bumping or other conditions, a clip lock may be disposed between the housing 12 and the cover 18. For example, the cover 18 may be locked with the housing 12 using the clip at closed position to prevent the cover 18 from moving around. When the cover 18 needs to be rotated, the shade 16 can pushes the cover 18 to be unlocked from the housing 12. For example, the first segment 20 of the cover 18 may include a lock tongue at a surface facing the second portion 36. The first portion 36 includes a lock latch matching with the lock tongue. When the shade 16 is retracted to the closed position, the lock tongue on the first segment 20 is inserted onto the lock latch on the first end to lock the cover 18 to prevent the cover 18 from swaying around.

The lock tongue may be made from an elastic material so that it can be deformed to be released from the lock latch when the shade pushes the first segment 20 while moving to the open position. Alternatively, the second segment 22 may be configured to be connected with the second portion 38 via the clip.

It should be understood that other locking mechanism such as hook-loop fastener or buckle, may be used to prevent the cover 18 from moving at the closed position.

Continuing with FIGS. 8 and 9, in some embodiments, the shade assembly 10 may further include a bias member 26 to bias the cover 18 toward to the open position where the gap 14 is exposed.

In some embodiments, the bias member 26 is a bias spring disposed on the pivot shaft 32 of the cover 18. It should be understood that the bias member 26 may be other possible structures that pull the cover 18 toward to an open position where the gap 14 is exposed. As such, when the shade 16 is deployed, the cover 18 remains in the opening position since the shade 16 no longer presses against the cover 18, that is, the cover 18 does not interfere with the movement of the shade 16 at the open position.

As shown FIG. 6, in some embodiments, the cover 18 further includes an actuator 24 that forms an angle with the first segment 20 and the second segment 22. In other words, the actuator 24 is a plate branching from the second segment 22 when viewing its projection on a plane perpendicular to the pivot shaft 32. In some embodiments, the actuator is a curved plate extending from the first segment 20 and curved toward the first segment 20 and away from the second segment 22.

In some embodiments, the cover 18 may include two actuators 24, each being positioned at opposite ends of the cover 18 along its width direction. That is, each actuator 24 is positioned adjacent an end of the gap 14. In this way, the actuator 24 will not interfere movement of the shade 16.

In some embodiments, the first segment 20, the second segment 22, and the actuator 24 may be integrally formed. That is, the cover 18 may be molded as one piece, which is easy to manufacture and no extra procedure is needed.

In some embodiments, the first segment 20, the second segment 22, and actuator 24 may be manufactured separately. For example, the first segment 20 and the second segment 22 may be made separately according to the length of gap 14 and the configuration of the housing 12, and the actuators 24 may be made separately and then assembled. It should be understood that the first segment 20 and the second segment 22 may be integrally formed and then connected with the actuator 24. The length of gap 14 refers to a length along with the extension direction of the gap, which is the direction of vehicle's left and right or a traverse direction.

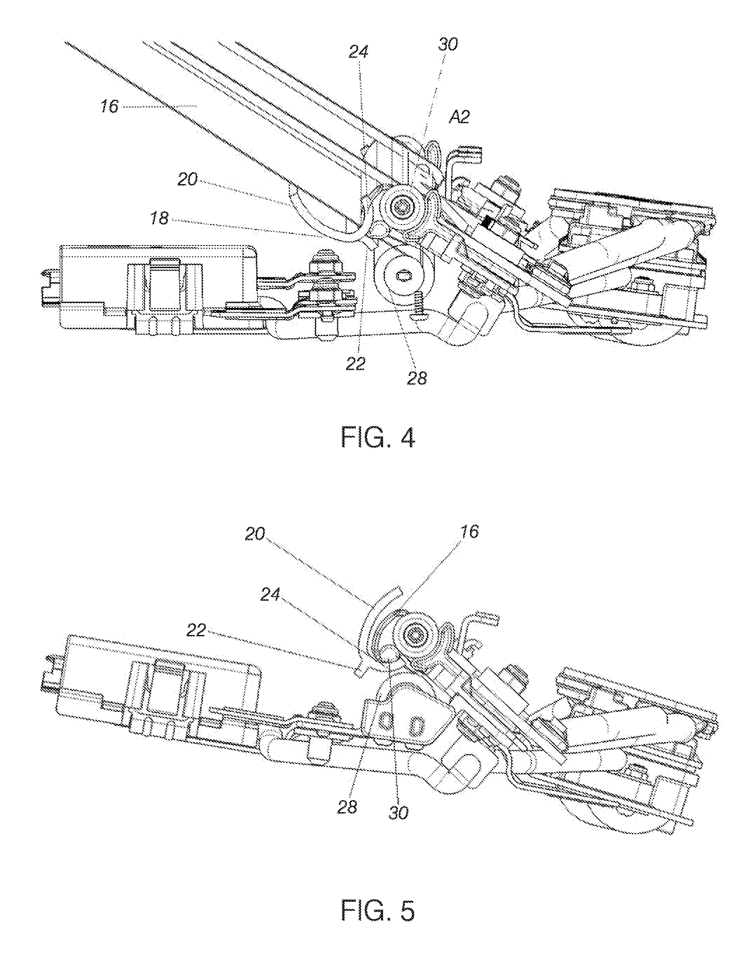

Returning to FIGS. 3 and 4, in some embodiments, the shade 16 winded on a reel 28 is driven by a top rod or a rod 30 to move in and out the housing 12. When the shade 16 moves into the inner side of the housing 12 from the outer side, the top rod 30 pushes the actuator 24 of the cover 18 to the closed position to conceal the gap 14 with the first segment 20 and the second segment 22. That is, the actuator 24 is positioned on a retracting path of the top rod 30. When the top rod 30 is retracted, the top rod 30 pushes the actuator 24 to make the actuator 24 to rotate around the pivot shaft 32 and drive the cover 18 to the closed position.

FIGS. 3 and 4 are schematic diagrams illustrating that the shade 10 is driven from the closed position A2 to the open position B2. The cover 18 and shade 16 are shown at the open position. The dash line shows a position of the top rod 30 while the shade 10 at closed position, the solid line shows position of the top rod 30 while the shade 10 at the open position. In FIG. 3, direction of the arrow D is a moving path of the top rod 30 when the shade 10 is driven from the closed position A2 to the open position B2.

FIG. 4 is a partial enlarged view of the shade assembly in FIG. 3. Similarly, the cover 18 and the shade 16 in FIG. 4 are shown at the open position, and the dash line shows the position of the top rod 30 while the shade assembly 10 is at the closed position.

In some embodiments, two protrudes are disposed on both ends of the top rod 30 to push the cover 18 to its closed position while the shade 16 is retracting. When the top rod 30 is retracted from the open position to the closed position, the protrusions push the actuator 24 of the cover 18 to make it pivotally rotate on the pivot shaft 32, which rotate the cover 18 to the closed position.

FIG. 5 is a schematic diagram of the shade assembly at a closed position. As shown in FIG. 5, in some embodiments, the top rod 30 pushes or drives the first segment 20 of the cover 18 to pivot the cover 18 so as to expose the gap 14 when the shade 16 moves to the outer side of the housing 12 from the inner side of the housing 12. As such, the top rod 30 drives the shade 16 to move to the open position.

In some embodiments, the top rod 30 may be driven by a motor so that a driver or a passenger can move the top rod 30 by pushing a button. It should be understood that the top rod 30 may be operated manually by the user.

In the embodiment shown FIGS. 1 and 2, the housing 12 may be a package tray of a rear window. It should be understood that the shade assembly 10 of the present disclosure can be used at any places in a vehicle that needs a shade. The shade assembly 10 may also be applied to other fields other than the vehicles.

According to another aspect of the present disclosure, a shade assembly is provided for a package tray of a rear window of a vehicle. The shade assembly comprises a rear window package tray with a gap 14 to allow a movement of the shade 16 in and out (corresponding to the housing 12 as illustrated above). The shade 16 is driven by the top rod 30. The shade assembly further includes the cover 18 pivotally connected with the rear window package tray and rotated between a closed position to conceal the gap 14 and an open position to expose the gap 14 relative to the rear window package tray. The cover 18 includes the first segment 20 and the second segment 22 extended from the first segment 20, and the first segment 20 and the second segment 22 of cover 18 contact the outer side and the inner side of the rear window package tray, respectively, at closed position. Since the cover 18 is disposed at the gap 14 and the cover 18 contacts the inner side and the outer side of the rear window package tray, respectively, the gap 14 can be concealed by the cover 18. As a result, the gap is covered from a view of the user such that the appearance of the package tray is improved and further can prevent the objects from falling into the interior of the shade at the rear window shelf.

In one embodiment, when the shade 16 moves out of the rear window package tray from the interior, the top rod 30 pushes the first segment 20 of the cover 18 to rotate the cover 18 from the closed position to the open position.

In one embodiment, the first segment is configured to be bended toward to the inner side of the rear window package tray to contact on the outer side or the outer surface of rear window package tray at the closed position.

In one embodiment, the second segment 22 is configured to be bended toward to outside of the rear window shelf to contact the inner side or the inner surface of rear window tray at closed position.

In one embodiment, the cover 18 further includes actuators disposed at two ends of the second segment 22 along with the pivot shaft 32 at an axial direction. The top rod 30 is configured push the actuators of the cover 18 to rotate the cover 18 from an open position to the closed position when the shade 16 enters the inner side of the rear window package tray from the outer side.

In one embodiment, the first segment 20, the second segment 22, and the actuator 24 are integrally formed.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions.

Note that the example control and estimation routines included herein can be used with various engine and/or vehicle system configurations. The specific routines described herein may represent one or more of any number of processing strategies such as event-driven, interrupt-driven, multi-tasking, multi-threading, and the like. As such, various acts, operations, or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated acts or functions may be repeatedly performed depending on the particular strategy being used. Further, the described acts may graphically represent code to be programmed into computer readable storage medium in the engine control system.

It will be appreciated that the configurations and routines disclosed herein are exemplary in nature, and that these specific embodiments are not to be considered in a limiting sense, because numerous variations are possible.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application.

1. A shade assembly in a vehicle, comprising:
a housing, wherein the housing includes a gap for moving in and out of a shade; and
a cover including a first segment and a second segment, wherein the cover is connected to the housing and moveable with the shade between a closed position to conceal the gap and an open position to expose the gap and wherein the first segment contacts an outer side of the housing and the second segment contacts an inner side of the housing at the closed position.

2. The shade assembly of claim 1, wherein the second segment extends from a first segment and the first and second segments are in different planes.

3. The shade assembly of claim 2, wherein a length of the first segment is greater than a length of the second segment at a direction of a shade movement.

4. The shade assembly of claim 3, wherein the first segment is a curved plate and configured to be bended toward the inner side of the housing to facilitate a contact with the outer side of the housing at the closed position.

5. The shade assembly of claim 4, wherein the second segment is a cured plate and configured to bend toward to the outer side of the housing to facilitate a contact with the inner side of the housing at the closed position.

6. The shade assembly of claim 2, wherein the cover includes a pivot shaft disposed at the inner side of the housing and connected with the housing.

7. The shade assembly of claim 6, further comprising a bias member to bias the cover at a position to expose the gap.

8. The shade assembly of claim 7, wherein the bias member is a bias spring sleeved on the pivot shaft of the cover.

9. The shade assembly of claim 7, wherein the cover further includes an actuator that forms an angle with the second segment.

10. The shade assembly of claim 9, wherein the first segment, the second segment and the actuator are formed integrally.

11. The shade assembly of claim 9, wherein the shade wound on a reel is activated by a top rod to move in and out of the housing, and when the shade is moved to the interior of the housing from the exterior, the top rod pushes the actuator of the cover to enable the first and second segments to conceal the gap, and wherein when the shade is moved to the exterior of the housing from the interior, the top rod pushes the first segment of the cover to rotate the cover to expose the gap.

12. The shade assembly of claim 11, wherein the top rod is driven by a motor.

13. The shade assembly of claim 1, wherein the housing is a package tray of a rear window.

14. A shade assembly of a rear window package tray in a vehicle, comprising:
a package tray of the rear window, wherein the package tray includes a gap to allow movement of a shade in and out of the gap, and the shade is driven by a top rod;
a cover, wherein the cover is pivotably connected to the package tray and moveable between a closed position to conceal the gap and an open position to expose the gap, wherein the cover includes a first segment and a second segment extending from the first segment and forming an angle with the first segment, the first segment of the cover contacts an outer side of the package tray and the second segment contacts an inner side of the package tray.

15. The shade assembly of claim 14, wherein the top rod pushes the first segment of the cover to move the cover from the closed position pivotally to the opening position when the shade moves from the interior of the package tray to the exterior.

16. The shade assembly of claim 15, wherein the cover further includes actuators positioned at opposite ends of the cover, and the actuators bend from end portions of the first segment and toward the first segment, wherein the top rod pushes the actuators to rotate the cover from the open position to the closed position when the cover moves from an exterior of the package tray to an exterior.

17. A cover used in a shade assembly in a vehicle to conceal a gap, the gap is located in a housing to allow the shade to move in and out of the housing, the cover comprising:
a first segment having a width adapted to a length;
a second segment extending from the first segment at a length direction and located in a plane different from the first segment; and
at least one actuator disposed on one end of the cover,
wherein the first segment contacts an outer side of the housing and the second segment contacts an inner side of the housing at a closed position to conceal the gap.

18. The cover of claim 17, wherein the first segment is a curved plate bended toward a first direction and the second segment is a curved plate bended to a second direction opposite to the first direction, and wherein the actuator extends from the first segment and curved toward the first segment and away from the second segment.

19. The cover of claim 18, wherein a length of first segment is greater than a length of the second segment.

20. The cover of claim 19, wherein the cover includes two actuators at two opposite ends and wherein the first segment, the second segment and the actuators are integrally formed.
